(19) United States
(12) Patent Application Publication
(10) Pub. No.: US 2004/0216930 A1
(43) Pub. Date: Nov. 4, 2004

(54) Electronic control system for differential

(76) Inventor: Don-Lon Yeh, Taichung City (TW)

Correspondence Address: DENNISON, SCHULTZ & DOUGHERTY, 612 Crystal Square 4, 1745 Jefferson Davis Highway, Arlington, VA, 22202-3417, US

(21) Appl. No.: 10/427,963

(22) Filed: May 2, 2003

(51) Int. Cl. B62D 11/00

(52) U.S. Cl. 180/6.5

(57) ABSTRACT

An electronic control system for a wheeled electric cart is disclosed. In response to a turning of the cart, a direction change signal proportional to an angle of rotation is generated by a steering controller and sensed by an angle of rotation sensor, and an electronic differential is adapted to receive a direction change signal and a speed signal respectively, perform a function about a distance between two rear wheels and a distance between front and rear wheels at the same side, the direction change signal, and the speed signal to generate a speed and direction change signal, transmit the speed and direction change signal to left and right motors for causing the left and right motor to rotate at different speeds, and cause the left and right wheels to turn in different speeds accordingly. The invention can carry out high transmission efficiency while turning curves.

### FIELD OF THE INVENTION

The present invention relates to differential control and more particularly to an electronic control system for differential in an electric cart with improved characteristics.

### BACKGROUND OF THE INVENTION

An arrangement of differential in a conventional internal combustion engine powered car or electric cart is illustrated in FIG. 1. As shown, a mechanical differential 91 is mounted in a rear axle. A power plant 90 is provided for transmitting power to the differential 91. As well known that outer wheels turn faster than inner wheels while the car is turning curve as the differential 91 operates.

However, the typical mechanical differential suffered from several disadvantages. For example, its construction is complicated. The number of components is excessive. It is bulky, low in transmission efficiency, and noisy. Further, lubricating oil may leak to cause pollution to the environment. The disadvantage of lower transmission efficiency is particularly undesirable in an electric cart since the rechargeable battery of the electric cart is limited in capacity. For instance, for an electric cart having high transmission efficiency a charge is required only, for example, after the cart has traveled 100 kilometers.

In contrast, for an electric cart having low transmission efficiency a charge is required, for example, after the cart has traveled only 50 kilometers. This can consume excessive power. Hence, a need for improvement exists.

### SUMMARY OF THE INVENTION

It is therefore an object of the present invention to provide an electronic control system for an electric cart having two front wheels and two rear wheels, comprising a steering controller comprising an angle of rotation sensor; a transmission mechanism each comprising a left motor and a right motor; a power controller adapted to control a power output of the transmission mechanism and generate a speed signal; a brake assembly adapted to generate a brake signal; and an electronic differential electrically connected to the steering controller, the power controller, and the transmission mechanism respectively; wherein in response to either a left turn of the steering controller a direction change signal proportional to an angle of rotation is generated by the steering controller and sensed by the angle of rotation sensor, and the electronic differential is adapted to receive the direction change signal and the speed signal transmitted from the angle of rotation sensor and the power controller respectively, perform a function about a first distance between the rear wheels and a second distance between the front and the rear wheels at the same side, the direction change signal, and the speed signal to generate a speed and direction change signal, transmit the speed and direction change signal to the transmission mechanism, cause the left motor to slow and the right motor to accelerate, and cause the left wheels to turn slower and the right wheels to turn faster respectively; or in response to either a right turn of the steering controller a direction change signal proportional to an angle of rotation is generated by the steering controller and sensed by the angle of rotation sensor, and the electronic differential is adapted to receive the direction change signal and the speed signal transmitted from the angle of rotation sensor and the power controller respectively, perform a function about a first distance between the rear wheels and a second distance between the front and the rear wheels at the same side, the direction change signal, and the speed signal to generate a speed and direction change signal, transmit the speed and direction change signal to the transmission mechanism, cause the right motor to slow and the left motor to accelerate respectively, and cause the right wheels to turn slower and the left wheels to turn faster respectively. By utilizing this, a high transmission efficiency of the four-wheeled cart while turning curves can be carried out.

It is another an object of the present invention to provide an electronic control system for an electric cart having a front wheel and two rear wheels, comprising a steering controller comprising an angle of rotation sensor; a transmission mechanism each comprising a left motor and a right motor; a power controller adapted to control a power output of the transmission mechanism and generate a speed signal; a brake assembly adapted to generate a brake signal; and an electronic differential electrically connected to the steering controller, the power controller, and the transmission mechanism respectively; wherein in response to either a left turn of the steering controller a direction change signal proportional to an angle of rotation is generated by the steering controller and sensed by the angle of rotation sensor, and the electronic differential is adapted to receive the direction change signal and the speed signal transmitted from the angle of rotation sensor and the power controller respectively, perform a function about a first distance between the rear wheels and a second distance between two parallel lines passing the front wheel and the rear wheels respectively, the direction change signal, and the speed signal to generate a speed and direction change signal, transmit the speed and direction change signal to the transmission mechanism, cause the left. motor to slow and the right motor to accelerate, and cause the left wheel to turn slower and the right wheels to turn faster respectively; or in response to either a right turn of the steering controller a direction change signal proportional to an angle of rotation is generated by the steering controller and sensed by the angle of rotation sensor, and the electronic differential is adapted to receive the direction change signal and the speed signal transmitted from the angle of rotation sensor and the power controller respectively, perform a function about a first distance between the rear wheels and a second distance between two parallel lines passing the front wheel and the rear wheels respectively, the direction change signal, and the speed signal to generate a speed and direction change signal, transmit the speed and direction change signal to the transmission mechanism, cause the right motor to slow and the left motor to accelerate, and cause the right wheel to turn slower and the left wheel to turn faster respectively. By utilizing this, a high transmission efficiency of the three-wheeled cart while turning curves can be carried out.

In one aspect of the present invention, in response to a 90-degree either right or left turn of the cart a center of rotation is at about center of a line connecting the rear wheels, the left and the right motors rotates in opposite directions but same speeds, and the cart turns by traveling a minimum arc length in situ.

The above and other objects, features and advantages of the present invention will become apparent from the following detailed description taken with the accompanying drawings.

### BRIEF DESCRIPTION OF THE DRAWINGS

FIG. 1 is a top plan view schematically depicting position of a conventional mechanical differential in an internal combustion engine powered car or electric cart;

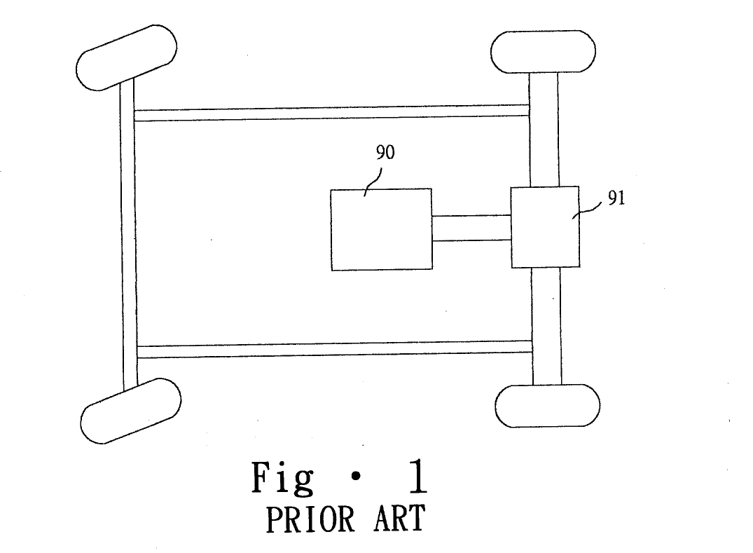

FIG. 2 is a perspective view schematically depicting components of a preferred embodiment of electronic control system for differential mounted in an electric cart according to the invention;

FIG. 3 is a top plan view schematically depicting positions of the components shown in FIG. 2;

FIG. 4 is a top plan view schematically depicting principles of turning curve of the cart shown in FIG. 2 as the differential operates;

FIG. 5 is a top plan view schematically depicting principles of turning curve of minimum arc length in situ in a four-wheel electric cart by the invention; and

FIG. 6 is a top plan view schematically depicting principles of turning curve of minimum arc length in situ in a three-wheel electric cart by the invention.

### DETAILED DESCRIPTION OF THE PREFERRED EMBODIMENTS

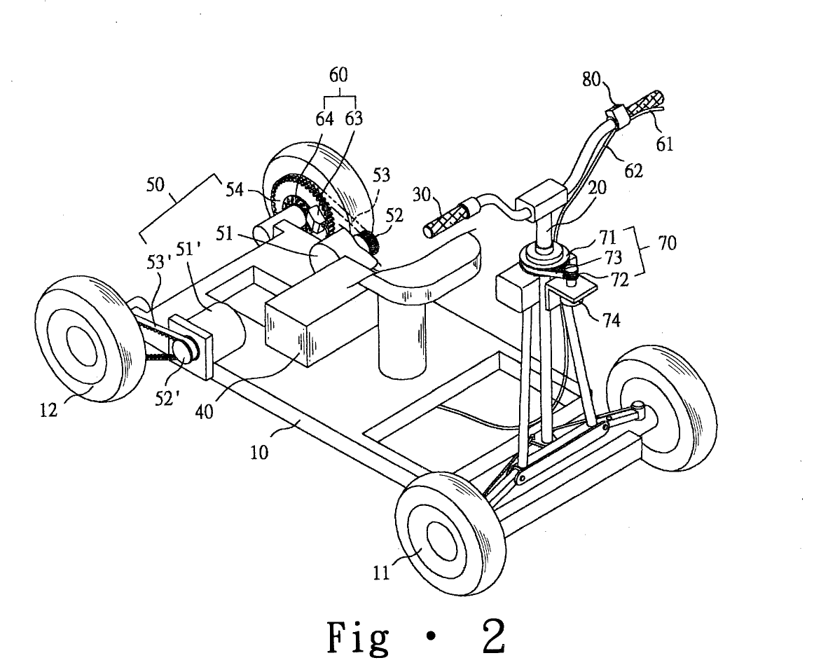

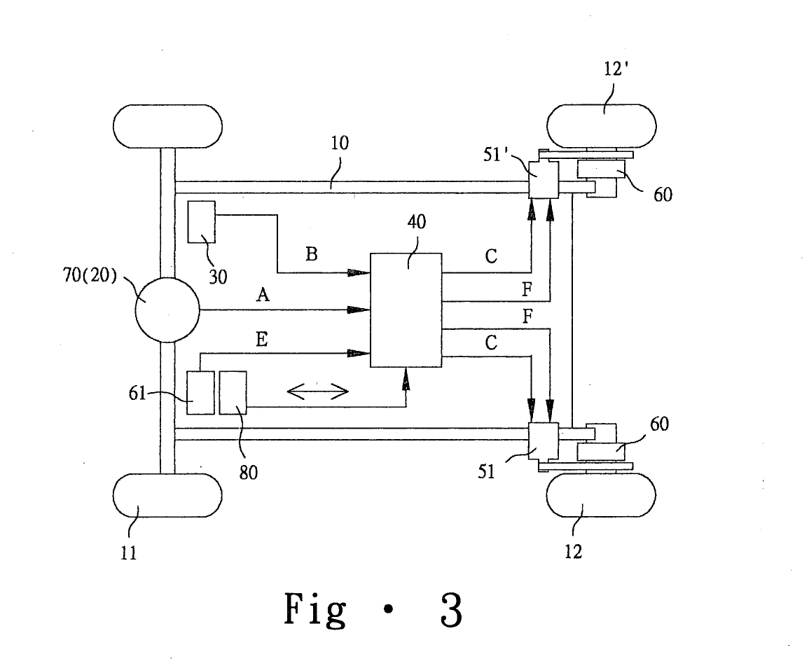

Referring to FIGS. 2, 3, and 4, there are shown an electric cart in accordance with the invention. The cart incorporates an electronic control system for differential. The control system comprises a chassis 10, a steering controller 20, a power controller 30, an electronic differential 40, a transmission mechanism 50, and a brake assembly 60. Each component will be described in detail below.

Two front wheels 11, 11′ and two rear wheels 12, 12′ are mounted at four corners of the chassis 10 in which the rear wheels 12, 12′ are driven by the transmission mechanism 50 directly.

The steering controller 20 is implemented as a handle (as shown), steering wheel or the like. An angle of rotation sensor 70 is provided at a lower portion of the steering controller 20 and is comprised of a disc scale 71 pivotal about the steering controller 20, a gear 72 spaced apart from the disc scale 71, a belt 73 fitted around the disc scale 71 and the gear 72, and a sensor 74 below the gear 72. In response to a turning of the steering controller 20, the gear 72 rotates the same as the disc scale 71 rotates by means of the belt 73. A direction change signal A proportional to the angle of rotation of the gear 72 is generated by the steering controller 20 and sensed by the sensor 74. The direction change signal A is then transmitted from the sensor 74 to the electronic differential 40.

The power controller 30 is implemented as a twist grip throttle (as shown) or the like. The power controller 30 is operative to control a power output of the transmission mechanism 50 and generate a speed signal B.

The electronic differential 40 functions as a signal integration calculator. The electronic differential 40 is electrically connected to the steering controller 20, the power controller 30, and the transmission mechanism 50 respectively. As such, the electronic differential 40 is able to receive the direction change signal A and the speed signal B transmitted from the. steering controller 20 and the power controller 30 respectively. Also, the electronic differential 40 is able to perform a function about a distance D between, for example, two rear wheels 12 and 12′, a distance L between, for example, a front wheel 11′ and a rear wheel 12′ at the same side, the direction change signal A, and the speed signal B (as detailed later). A speed and direction change signal C is generated as a result of performing the function. The speed and direction change signal C is then transmitted to the transmission mechanism 50.

The transmission mechanism 50 consists of two units each comprising a motor 51 or 51′, a pinion 52 or 52′, a chain 53 or 53′, and a gearwheel 54 connected to the rear wheel 12 or 12′ so that the rear wheels 12 and 12′ can turn together. When the motors 51, 51′ are activating, the rear wheels 12, 12′ are turning as motive force is transmitted from the motors 51, 51′ to the rear wheels 12, 12′ via the pinions 52, 52′ and the chains 53, 53′. At the same time, the speed and direction change signal C generated by the electronic differential 40 is transmitted to the motors 51, 51′ respectively. As an end, two different axle speeds and two different turning directions may be generated by the electronic differential 40 if the cart (i.e., the chassis 10) is turning curve.

The brake assembly 60 is comprised of a brake lever 61, a 20 brake cable 62 connected to the brake lever 61, two brakes 63 connected to the brake cable 62, and two brake discs 64 activated by the brakes 63 for stopping a turning of the rear wheels 12, 12′ by generating a brake signal E which is in turn transmitted to the electronic differential 40. The electronic differential 40 then generates a motor stop signal F and transmits to the transmission mechanism 50 in response to a receiving of the brake signal E. As an end, the motors 51, 51′ are stopped. The direction change signal A and the speed signal B are transmitted from the steering controller 20 and the power controller 30 to the electronic differential 40 respectively while the cart is running. Next, the electronic differential 40 performs the above function for generating a speed and direction change signal C which is in turn transmitted to the transmission mechanism 50. As a result, the rear wheels 12, 12′ are driven.

A signal about a straight traveling of the cart is sensed by the angle of rotation sensor 70 when the cart travels either straight forward or reverse. In this case the electronic differential 40 only processes the speed signal B for maintaining constant rotating speeds of the motors 51, 51′. In other words, no signal about a difference in axle speeds is generated by the steering controller 20. Once a brake signal E is generated, the electronic differential 40 will activate to slow or stop the motors 51, 51′ and thus the cart.

In a case that the cart is making a left turn the angle of rotation sensor 70 will sense an angle of rotation and generate a direction change signal A proportional to the angle of rotation. Next, the electronic differential 40 performs the function about the direction change signal A and the speed signal B for generating a speed and direction change signal C which is in turn transmitted to the transmission mechanism 50. As a result, the left motor 51 slows and the right motor 51′ accelerates, i.e., there is a difference between the rotating speeds of the motors 51 and 51′. To the contrary, in another case that the cart is making a right turn the angle of rotation sensor 70 will sense an angle of rotation and generate a direction change signal A proportional to the angle of rotation. Next, the electronic differential 40 performs the function about the direction change signal A and the speed signal B for generating a speed and direction change signal C which is in turn transmitted to the transmission mechanism 50. As a result, the left motor 51 accelerates and the right motor 51′slows, i.e., there is another difference between the rotating speeds of the motors 51 and 51′. Note that the faster of the cart and the larger of the angle of rotation the larger of either difference. In other words, this is a continuous speed adjustment. A reverse switch 80 is provided on the steering controller 20 for controlling a reverse of the motors 5 1, 51′ and thus the cart.

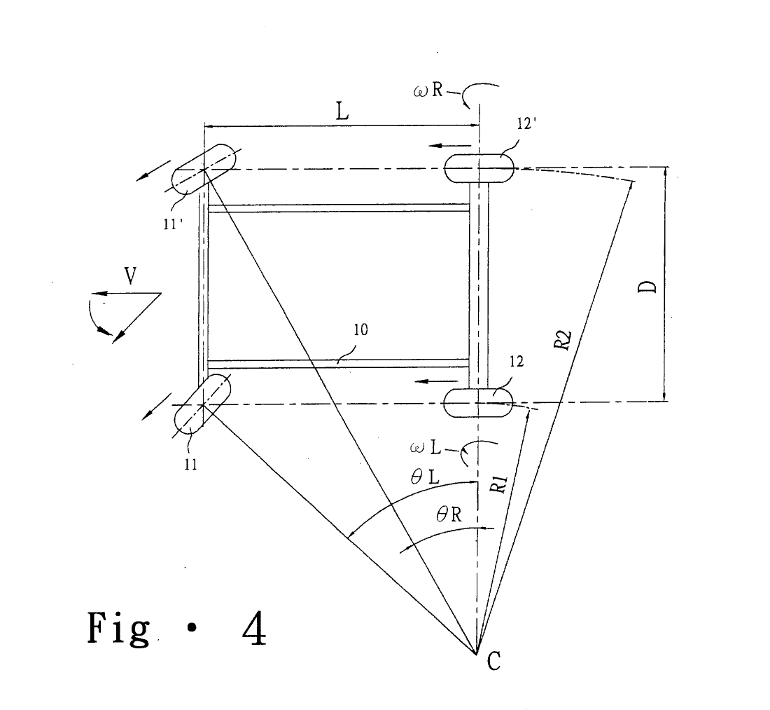

Referring to FIG. 4 specifically, principles of turning curve of the cart are illustrated. A speed difference between the rear wheels 12 and 12′ is a function of speed V of the cart, angle of rotation □, distance D between the rear wheels or the front wheels, and a distance L between the front wheel and the rear wheel at the same side. In a case that the cart is making a left turn the chassis 10 will turn about a center of rotation C. Also, the left rear wheel 12 will turn in a speed □L. Further, the right rear wheel 12′ will turn in a speed □R. The speed of the left rear wheel 12 (or the left front wheel 11) is smaller than that of the right rear wheel 12′ (or the right front wheel 11′) because a radius of curvature R1 of the left rear wheel 12 (or the left front wheel 11) is smaller than a radius of curvature R2 of the right rear wheel 12′ (or the right front wheel 11′). Likewise, an angle of rotation □L of the left front wheel 11 is larger than an angle of rotation □R of the rignt front wheel 11′. The same principles apply to a case that the cart makes a right turn.

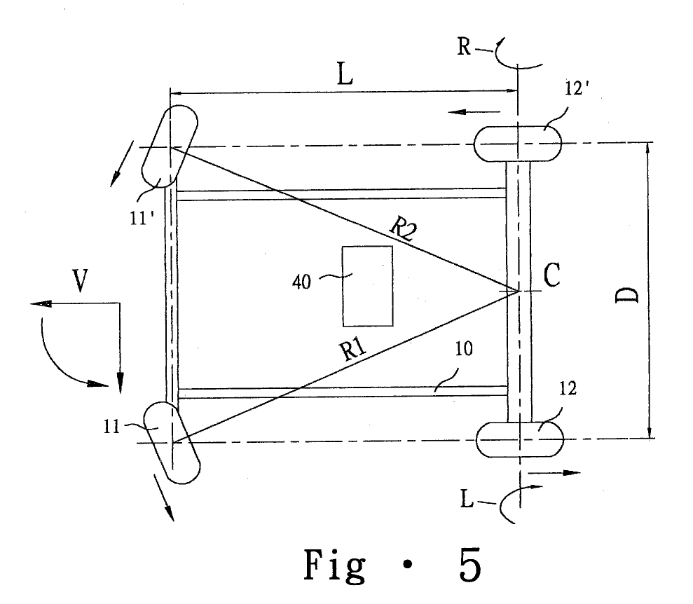

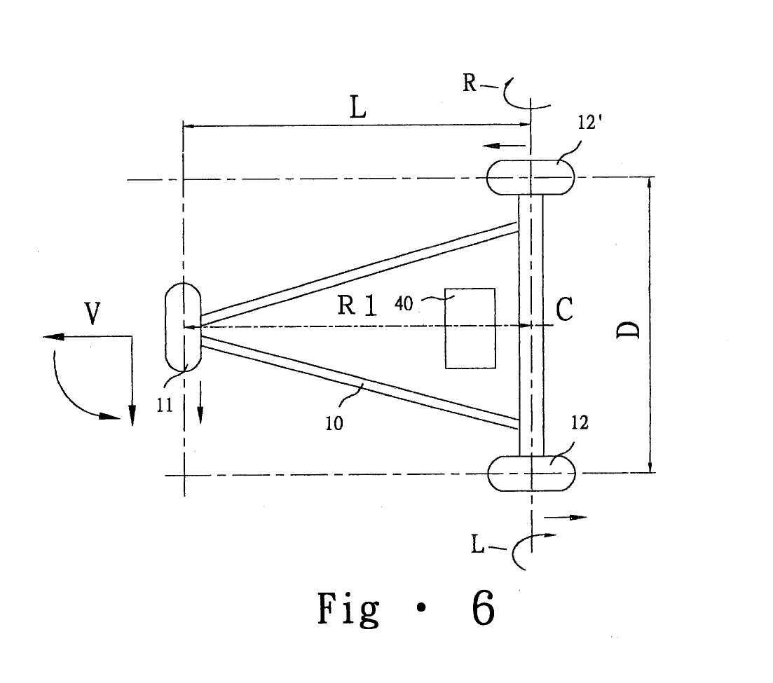

Referring to FIGS. 5 and 6, principles of turning curve of minimum arc length in situ in a four-wheel or three-wheel electric cart are illustrated. In a case that the cart is making a 90-degree left turn a center of rotation C is at about center of a line connecting the rear wheels 12, 12′, the left motor 51 will rotate in a direction reverse to that of the right motor 51′ but their speeds are the same. As an end, the cart will turn by traveling a minimum arc length in situ.

While the invention has been described by means of specific embodiments, numerous modifications and variations could be made thereto by those skilled in the art without departing from the scope and spirit of the invention set forth in the claims.

What is claimed is:

1. An electronic control system for an electric cart having two front wheels and two rear wheels, comprising:
a steering controller comprising an angle of rotation sensor;
a transmission mechanism each comprising a left motor and a right motor;
a power controller adapted to control a power output of the transmission mechanism and generate a speed signal;
a brake assembly adapted to generate a brake signal; and
an electronic differential electrically connected to the steering controller, the power controller, and the transmission mechanism respectively;
wherein in response to either a left turn of the steering controller a direction change signal proportional to an angle of rotation is generated by the steering controller and sensed by the angle of rotation sensor, and the electronic differential is adapted to receive the direction change signal and the speed signal transmitted from the angle of rotation sensor and the power controller respectively, perform a function about a first distance between the rear wheels and a second distance between the front and the rear wheels at the same side, the direction change signal, and the speed signal to generate a speed and direction change signal, transmit the speed and direction change signal to the transmission mechanism, cause the left motor to slow and the right motor to accelerate, and cause the left wheels to turn slower and the right wheels to turn faster respectively; or in response to either a right turn of the steering controller a direction change signal proportional to an angle of rotation is generated by the steering controller and sensed by the angle of rotation sensor, and the electronic differential is adapted to receive the direction change signal and the speed signal transmitted from the angle of rotation sensor and the power controller respectively, perform a function about a first distance between the rear wheels and a second distance between the front and the rear wheels at the same side, the direction change signal, and the speed signal to generate a speed and direction change signal, transmit the speed and direction change signal to the transmission mechanism, cause the right motor to slow and the left motor to accelerate respectively, and cause the right wheels to turn slower and the left wheels to turn faster respectively.

2. The electronic control system of claim 1, wherein responsive to receiving the brake signal from the brake assembly, the electronic differential generates a motor stop signal and transmits the motor stop signal to the transmission mechanism for stopping the motors.

3. The electronic control system of claim 1, wherein the angle of rotation sensor comprises a disc scale pivotal about the steering controller, a gear spaced apart from the disc scale, a belt fitted around the disc scale and the gear, and means for sensing below the gear so that in response to the turning of the steering controller, the gear rotates the same as the disc scale rotates by means of the belt and the means for sensing senses the direction change signal.

4. The electronic control system of claim 1, wherein in response to a 90-degree either right or left turn of the cart a center of rotation is at about center of a line connecting the rear wheels, the left and the right motors rotates in opposite directions but same speeds, and the cart turns by traveling a minimum arc length in situ.

5. An electronic control system for an electric cart having a front wheel and two rear wheels, comprising:
a steering controller comprising an angle of rotation sensor;
a transmission mechanism each comprising a left motor and a right motor;
a power controller adapted to control a power Qutput of the transmission mechanism and generate a speed signal;
a brake assembly adapted to generate a brake signal; and
an electronic differential electrically connected to the steering controller, the power controller, and the transmission mechanism respectively;
wherein in response to either a left turn of the steering controller a direction change signal proportional to an angle of rotation is generated by the steering controller and sensed by the angle of rotation sensor, and the electronic differential is adapted to receive the direction change signal and the speed signal transmitted from the angle of rotation sensor and the power controller respectively, perform a function about a first distance between the rear wheels and a second distance between two parallel lines passing the front wheel and the rear wheels respectively, the direction change signal, and the speed signal to generate a speed and direction change signal, transmit the speed and direction change signal to the transmission mechanism, cause the left motor to slow and the right motor to accelerate, and cause the left wheel to turn slower and the right wheels to turn faster respectively; or in response to either a right turn of the steering controller a direction change signal proportional to an angle of rotation is generated by the steering controller and sensed by the angle of rotation sensor, and the electronic differential is adapted to receive the direction change signal and the speed signal transmitted from the angle of rotation sensor and the power controller respectively, perform a function about a first distance between the rear wheels and a second distance between two parallel lines passing the front wheel and the rear wheels respectively, the direction change signal, and the speed signal to generate a speed and direction change signal, transmit the speed and direction change signal to the transmission mechanism, cause the right motor to slow and the left motor to accelerate, and cause the right wheel to turn slower and the left wheel to turn faster respectively.

6. The electronic control system of claim 5, wherein responsive to receiving the brake signal from the brake assembly, the electronic differential generates a motor stop signal and transmits the motor stop signal to the transmission mechanism for stopping the motors.

7. The electronic control system of claim 5, wherein the angle of rotation sensor comprises a disc scale pivotal about the steering controller, a gear spaced apart from the disc scale, a belt fitted around the disc scale and the gear, and means for sensing below the gear so that in response to the turning of the steering lo controller, the gear rotates the same as the disc scale rotates by means of the belt and the means for sensing senses the direction change signal.

8. The electronic control system of claim 5, wherein in response to a 90-degree either right or left turn of the cart a center of rotation is at about center of a line connecting the rear wheels, the left and the right motors rotates in opposite directions but same speeds, and the cart turns by traveling a minimum arc length in situ.
